(19) United States
(12) Patent Application Publication
(10) Pub. No.: US 2026/0065644 A1
(43) Pub. Date: Mar. 5, 2026

(54) DETECTION OF STEALTHY BITSTREAMS IN FIELD PROGRAMMABLE GATE ARRAYS (FPGAs)

(71) Applicants: Jayeeta Chaudhuri, Tempe, AZ (US); Krishnendu Chakrabarty, Chandler, AZ (US)

(72) Inventors: Jayeeta Chaudhuri, Tempe, AZ (US); Krishnendu Chakrabarty, Chandler, AZ (US)

(73) Assignee: ARIZONA BOARD OF REGENTS ON BEHALF OF ARIZONA STATE UNIVERSITY, Scottsdale, AZ (US)

(21) Appl. No.: 19/313,207

(22) Filed: Aug. 28, 2025

Related U.S. Application Data
(60) Provisional application No. 63/688,471, filed on Aug. 29, 2024.

(51) Int. Cl. G06V 10/764; G06T 5/10; G06T 7/11; G06V 10/426; G06V 10/60; G06V 10/74

(52) U.S. Cl. CPC G06V 10/764; G06T 5/10; G06T 7/11; G06V 10/426; G06V 10/60; G06V 10/761

(57) ABSTRACT

A method of detecting stealthy bitstreams in field programmable gate arrays (FPGAs) includes receiving an FPGA bitstream for configuring an FPGA; converting the FPGA bitstream into images; generating a graph from the images using a similarity evaluation; and performing a classification of the FPGA bitstream as benign or malicious using the graph as input to a graph convolutional network.

### GOVERNMENT SUPPORT

This invention was made with government support under 2011561 awarded by the National Science Foundation. The government has certain rights in the invention.

### BACKGROUND

Multi-tenant field programmable gate arrays (FPGAs) are reconfigurable hardware platforms that are often used in cloud computing centers, high-performance computing, and neural network accelerators. The shared environment in multi-tenancy FPGAs introduces attack vectors that can be exploited by a third-party adversary. Malicious bitstreams implementing ring oscillator (RO)-based circuits can be configured on multi-tenant FPGAs. Composed of a chain of odd number of inverters, ROs can be manipulated for generating high-frequency oscillations and can be potentially exploited to launch voltage-based attacks and denial-of-service (DoS) attacks.

Prior work on bitstream detection focuses on checking a bitstream before FPGA configuration via reverse-engineering (RE) and machine learning (ML)-based methods. However, RE is a time-intensive procedure and often requires significant modification of the reversal tools to adapt to larger bitstreams. In addition, an adversary can craft obfuscated ROs to increase power consumption, while evading detection by ML-based methods that rely on contiguous windows of an FPGA bitstream for malicious circuit detection. These methods do not consider the spatial relationship among the windows. For example, an attacker can split the inverters of an RO design across multiple look-up tables (LUTs) of an FPGA, making the malicious RO patterns in the bitstream appear to be distributed.

Therefore, there is a need for detection techniques that consider the spatial context and are capable of identifying dispersed and obfuscated malicious patterns.

### BRIEF SUMMARY

Systems and Techniques for detection of stealthy bitstreams in FPGAs are provided. Through the described techniques, it is possible to detect a wide range of RO variants, including loop-free ROs, power-wasting circuits, and stealthy, power-wasting Trojans.

In some aspects, the techniques described herein relate to a method of detecting stealthy bitstreams in FPGAs, including: receiving an FPGA bitstream for configuring an FPGA; converting the FPGA bitstream into images; generating a graph from the images using a similarity evaluation; and performing a classification of the FPGA bitstream as benign or malicious using the graph as input to a graph convolutional network.

A system for detecting stealthy bitstreams in FPGAs can include: a convolutional neural network (CNN); a graph convolutional network (GCN); a multilayer perceptron (MLP); one or more processors; memory; and instructions for detecting stealthy bitstreams in FPGAs stored in the memory that when executed by at least one of the one or more processors direct the system to: receive an FPGA bitstream for configuring an FPGA; partition the FPGA bitstream into non-overlapping windows; input the non-overlapping windows of the FPGA bitstream to the CNN to generate a first feature set; convert each bitstream window of the non-overlapping windows of the FPGA bitstream to an image; generate a graph from the images using a similarity evaluation; generate node embeddings from the graph using the GCN having a feature vector including a combination of the first feature set and a second feature set generated from applying a Fast Fourier Transform on each bitstream window; and perform machine learning inference on the node embeddings using the MLP to classify the FPGA bitstream as benign or malicious.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates an example threat model for multi-tenant FPGAs.

FIGS. 2A and 2B illustrate a method of detecting stealthy bitstreams in FPGAs.

FIGS. 3A and 3B illustrate an example similarity evaluation performed on image files.

FIGS. 4A and 4B illustrate an example implementation of a method of detecting stealthy bitstreams in FPGAs.

FIG. 5 shows a representation of a system for detection of stealthy bitstreams in FPGAs.

### DETAILED DESCRIPTION

Systems and Techniques for detection of stealthy bitstreams in FPGAs are provided. Through the described techniques, it is possible to detect a wide range of RO variants, including loop-free ROs, power-wasting circuits, and stealthy, power-wasting Trojans.

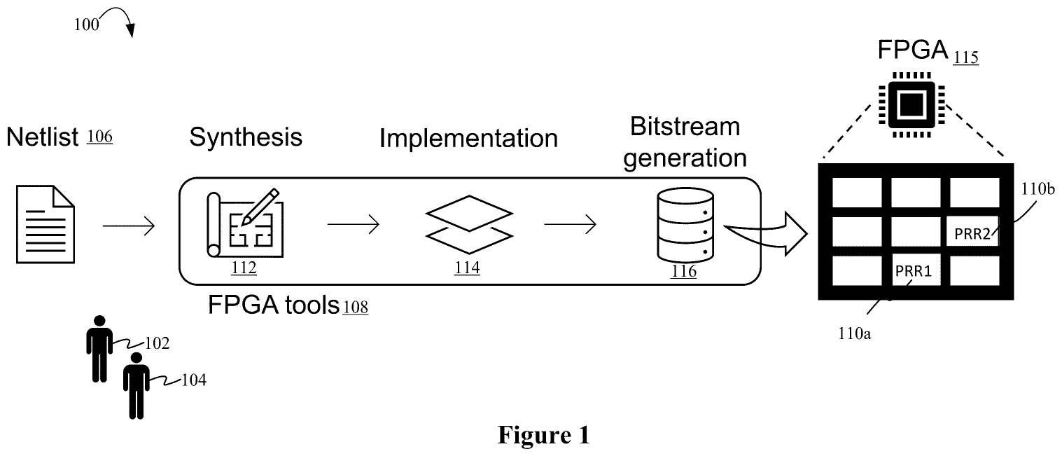

FIG. 1 illustrates an example threat model for multi-tenant FPGAs. Referring to FIG. 1, operating environment 100 illustrates entry points for possible threats posed to FPGA-based cloud computing systems. Currently, there are several cloud offerings (e.g., Amazon AWS, Microsoft Azure, etc.) that allow users to upload designs into the cloud for executions. For example, a machine learning model can be mapped onto FPGAs and run in the cloud. These large FPGAs are shared in a multi-tenant framework, so multiple users can have access to the same FPGA simultaneously.

In a multi-tenant scenario, several users, including user 102, can upload their customized modules, in the form of FPGA bitstreams, to be implemented on one or more of the partial reconfigurable regions (PRRs) of an FPGA 115 (e.g., PRR1 110a and PRR2 110b).

While being separately allocated to different tenants, the PRRs 110a, 110b may still share a common power distribution network (PDN). As such, an adversary 104 may be able to disrupt performance of other tenants' operations by inducing excessive power consumption on the FPGA using their own uploaded customized module or by inserting a design into another's customized module. A PDN of a multi-tenant FPGA is typically configured to supply power to all of the modules within the multi-tenant FPGA. Since the voltage drop across the PDN is dependent on the summation of voltage drops across all the reconfigurable modules of the FPGA, excessive power consumption/voltage drop at one module can affect the power supplied to other modules.

An adversary might deploy malicious power-wasting circuits as part of their customized modules on the FPGA that impacts the PDN, leading to voltage fluctuations and subsequently, DoS. For example, a ring oscillator (RO) is a series of an odd number of NOT gates whose output states are balanced between two voltage levels. A RO can be used as a malicious circuit to cause voltage-based attacks on the FPGA 115. In some cases, activating a large number of ROs at a particular frequency can be sufficient to cause significant power consumption, causing the FPGA to shut down automatically. As another example, glitch generator circuits using XOR gates and delay lines can be implemented. These glitch generator circuits draw excessive power from the PDN, which can result in undesirable voltage fluctuations affecting other modules on the same FPGA. In extreme cases, such excessive power draw might even lead to DoS of the FPGA. Loop-free oscillators can also result in DoS scenarios. Additional power-wasting circuits may be created by carefully inserting XOR gates between AES rounds or by generating chains of shift registers.

As mentioned above, the malicious circuits may be part of a customized module uploaded by an adversary or inserted into another's design. For example, as part of the threat model, an attacker may insert malicious designs in any number of locations in the process flow. As shown in FIG. 1, a circuit design can be represented in a netlist 106 that is converted, through FPGA tools 108, into a bitstream that is uploaded to the FPGA 115 and programmed into the FPGA 115 hardware. The netlist 106 can begin as an RTL file, which describes the circuit at the register-transfer level. FPGA tools 108 can include electronic design automation (EDA) tools including synthesis 112 and route and placement/implementation 114. In addition, the FPGA tools 108 can include bitstream generation 116.

In this process flow, as one threat model, it is possible that an attacker gaining illegitimate access to the placed and routed netlist (e.g., as part of synthesis 112 or implementation 114 of the FPGA tool) might embed malicious circuits before bitstream generation 116. Another threat model is the scenario where an attacker attempts to alter the bitstream during its transmission to the FPGA 115 before deployment/configuration on the FPGA 115. Accordingly, applying the methods described herein for detecting stealthy bitstreams can facilitate identification (and removal) of potentially malicious modules regardless of whether the malicious circuits were inserted at the original design or later in the process including during transmission of the FPGA bitstream. These bitstreams containing potentially malicious circuits can be considered “stealthy bitstreams” since the malicious circuitry is not readily apparent due to the dispersed patterns and other techniques to hide (or otherwise evade detection of) the malicious circuitry by attackers.

An FPGA bitstream can include, among other information, a description of hardware logic, routing, and initial values for registers and on-chip memory of an FPGA. For example, an FPGA bitstream can have a sequence of contiguous frames. Each frame encapsulates a set of LUTs (look up tables) and other functional blocks within the FPGA 115 and corresponds to a specific portion of the FPGA 115 fabric. In other words, the bitstream configuration data is directly correlated to the frames it configures on the FPGA 115. Therefore, if RO circuits are intentionally dispersed by an adversary across various LUTs, their patterns in the resulting bitstream may not be contiguous. Sequentially placed frames typically correspond to a consistent mapping of configuration data on the bitstream. By distributing ROs across various frames, the adversary 104 disrupts this sequential alignment. A number of FPGA cloud computing systems incorporate design rule checking (DRC) as part of the FPGA tools 108, which can check for certain circuits used by attackers. However, a number of different circuits and approaches can evade such checks. Similarly, ML-based detection methods that learn malicious patterns from contiguous bitstream data may not be capable of detecting these ROs as they are no longer in a recognizable sequence within the bitstream.

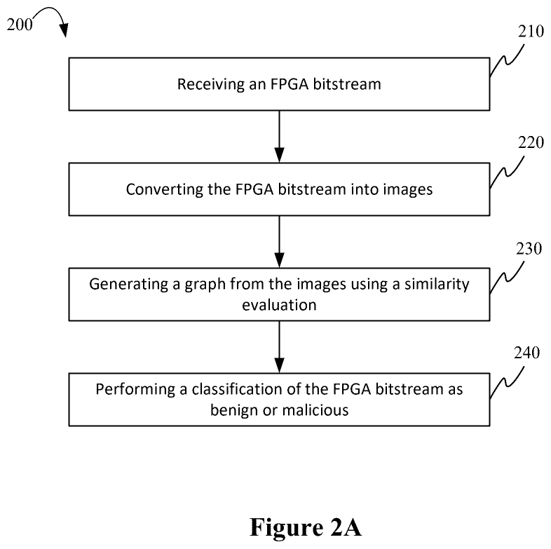

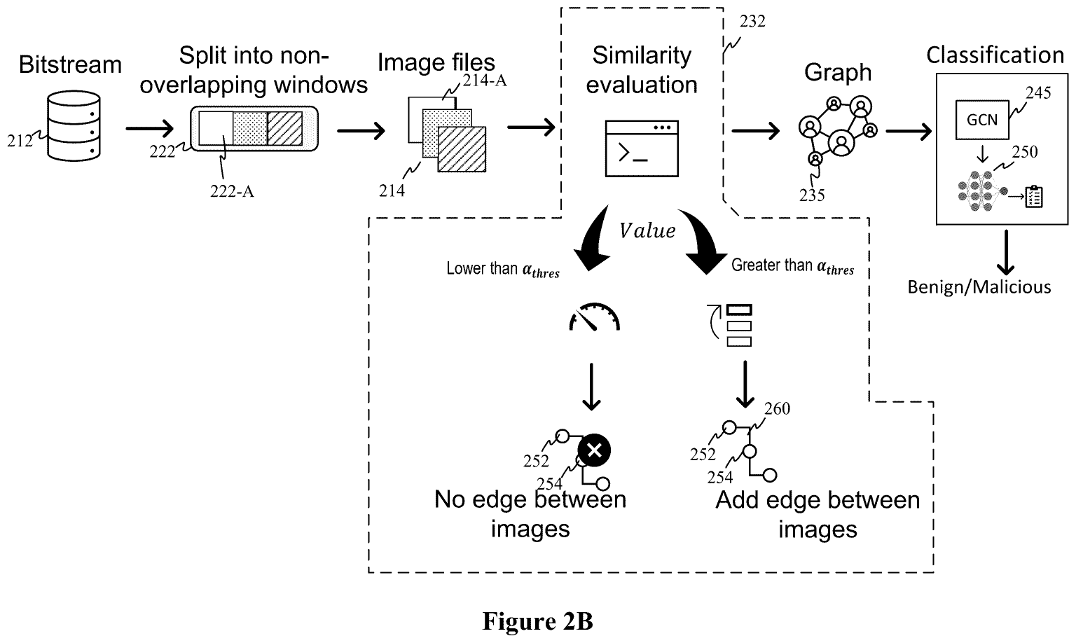

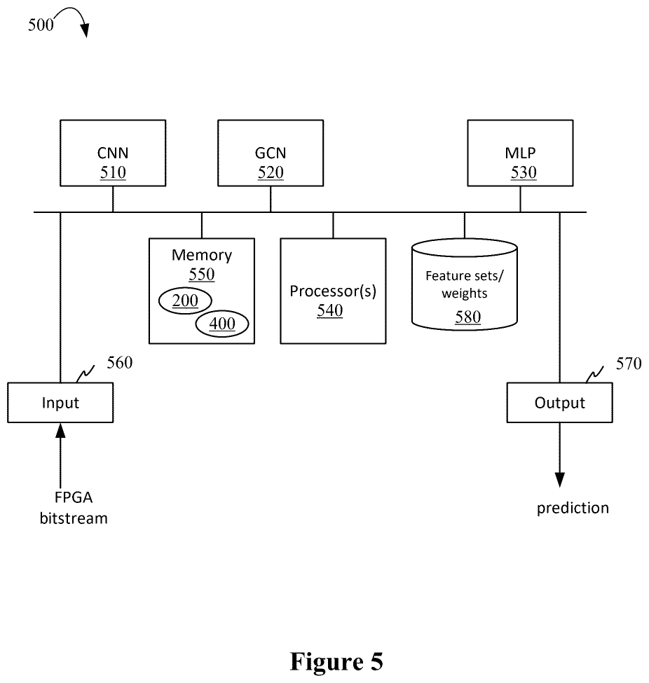

FIGS. 2A and 2B illustrate a method of detecting stealthy bitstreams in FPGAs. Referring to FIGS. 2A and 2B, a method 200 of detecting stealthy bitstreams in FPGAs can include receiving (210) an FPGA bitstream 212 for configuring an FPGA; converting (220) the FPGA bitstream 212 into images 214; generating (230) a graph 235 from the images using a similarity evaluation 232; and performing (240) a classification of the FPGA bitstream as benign or malicious using the graph 235 as input to a graph convolutional network 245. Method 200 can be carried out by a system such as system 500 of FIG. 5, which can communicate with or be part of a FPGA cloud computing system supporting the management and programming of FPGA hardware (e.g., FPGA 115 of FIG. 1) and/or FPGA tools (e.g., FPGA tools 108 of FIG. 1). The FPGA bitstream can be for configuring an FPGA deployed on a shared FPGA infrastructure. In some cases, method 200 can then further include analyzing the FPGA bitstream for dispersed malicious circuits having components distributed across non-contiguous look-up tables based on the classification; and prevent deployment of the FPGA bitstream on the shared FPGA infrastructure when malicious dispersed circuits are detected. In some cases, it is possible to incorporate/integrate the described methods and systems with existing security infrastructure including integrations with DRC systems.

A graph convolutional network (GCN) is a semi-supervised ML model that operates on graph-structured data. A graph consists of a set of nodes and edges. A GCN aggregates feature information from adjacent nodes and subsequently generates node embeddings. These embeddings can represent information about the nodes and their spatial relations.

Advantageously, GCNs can be used to learn spatial relationships in bitstream data and capture malicious patterns in the FPGA bitstreams. Based on a supervised learning approach, GCN leverages both structural information and the dependencies within bitstream data to detect malicious patterns corresponding to power-wasting circuits. The GCN utilizes two inputs: a feature matrix and an adjacency matrix. The feature matrix represents the features of interest. The adjacency matrix represents the graph. As described herein, the FPGA bitstream 212 is able to be operated on by the GCN by conversion into a graph.

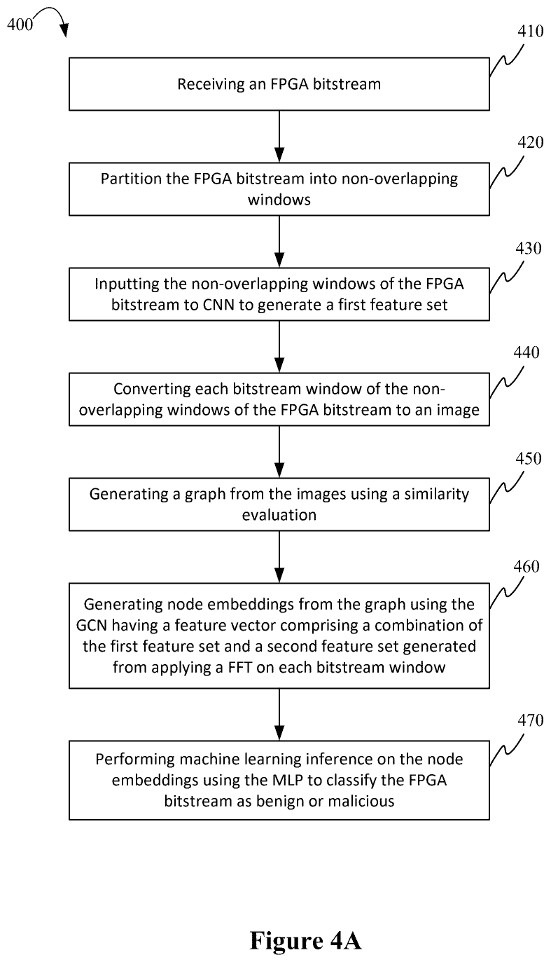

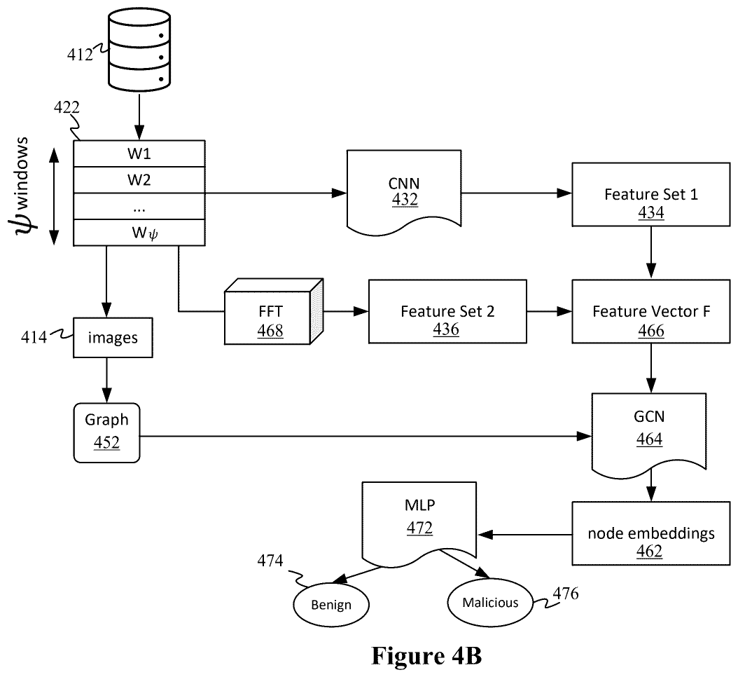

Converting (220) the FPGA bitstream 212 into images 214 can include partitioning the FPGA bitstream into non-overlapping windows 222 and converting each bitstream window of the non-overlapping windows 222 of the FPGA bitstream 212 to an image. For example, bitstream window 222-A is converted to image 214-A. In some cases, such as described in further detail with respect to FIG. 4B, a support vector machine can be used to determine an optimal number of windows 222.

When generating (230) the graph 235 from the images, the similarity evaluation 232 can be used to analyze spatial relationships between bitstream segments. Generating (230) the graph 235 from the images using a similarity evaluation 232 can include assigning each image as a node (e.g., 252, 254) of the graph 235; obtaining a similarity value between image pairs of the images; and adding an edge 260 between the two nodes 252, 254 corresponding to the two images of each image pair having the similarity value above a threshold.

For every n images, there can be n choose 2 combinations that can be compared. During the similarity evaluation 232, the images 214 are compared to determine a similarity value between two images. A similarity value can be based on a comparison of features including luminance, contrast, and structure. This facilitates the construction of a meaningful graph structure that captures spatial similarities within the bitstream windows and subsequently aids the GCN model in identifying malicious signatures. A variety of different similarity metrics may be used for performing the similarity evaluation 232. Examples of similarity metrics that may be used to determine similarity values include, but are not limited to, a correlation coefficient measure (CMSC) such as the Pearson correlation coefficient (PCC) (e.g., as described by Adler, J., & Parmryd, I. (2010). Quantifying colocalization by correlation: The Pearson correlation coefficient is superior to the Mander's overlap coefficient. Cytometry Part A, 77a(8), 733-742), a scale invariant feature transform (SIFT) (e.g., as described by Lowe, D. G. (2004). Distinctive image features from scale-invariant keypoints. International Journal of Computer Vision, 60 (2), 91-110), and a structural similarity index metric (SSIM).

As an illustrative embodiment, the SSIM metric is used as part of the similarity evaluation 232 for generating an adjacency matrix A that represents the graph.

For example, for a bitstream split into ψ windows, the resultant adjacency matrix A will have dimensions ψ×ψ. For example, each bitstream window 222 can be converted into an image representation Imᵢ (e.g., each image of image files 214). For an image pair (Imᵢ, Imⱼ), 1≤i, j≤ψ, i≠j, the SSIM value can be calculated as

$$SSIM ( {Im}_{i} , {Im}_{j} ) = \frac{( 2 {μ}_{{Im}_{i}} {μ}_{{Im}_{j}} + {( {k}_{1} l )}^{2} ) ( 2 {σ}_{{Im}_{i} , {Im}_{j}} + {( {k}_{2} l )}^{2} )}{( {μ}_{{Im}_{i}}^{2} + {μ}_{{Im}_{j}}^{2} + {k}_{1} l ) ( {σ}_{{Im}_{i}}^{2} + {σ}_{{Im}_{j}}^{2} + {k}_{2} l )} ,$$

wherein μ_{Im}_{ᵢ} and μ_{Im}_{ⱼ} indicate the mean pixel value of Imᵢ and Imⱼ, respectively, wherein

$${σ}_{{Im}_{i}}^{2} and {σ}_{{Im}_{j}}^{2}$$

indicate the variance of Imᵢ and Imⱼ, respectively, wherein σ_{Im}_{ᵢ}_{,Im}_{ⱼ} is the covariance of the image pair, and wherein l is the range of the pixel values (e.g., 0-255). The parameters k1 and k2 are predetermined values. The default values for k₁ and k₂ are 0.01 and 0.03, respectively.

The range of SSIM is [0,1] where 1 indicates a high similarity and 0 indicates no similarity. If SSIM (Imᵢ, Imⱼ) is greater than a pre-defined threshold ∝ₜₕᵣₑₛ, 0≤∝ₜₕᵣₑₛ≤1, then Aᵢⱼ=1 (indicating an edge); otherwise, Aᵢⱼ=0 (indicating no edge), where Aᵢⱼ indicates the presence or absence of edges between windows.

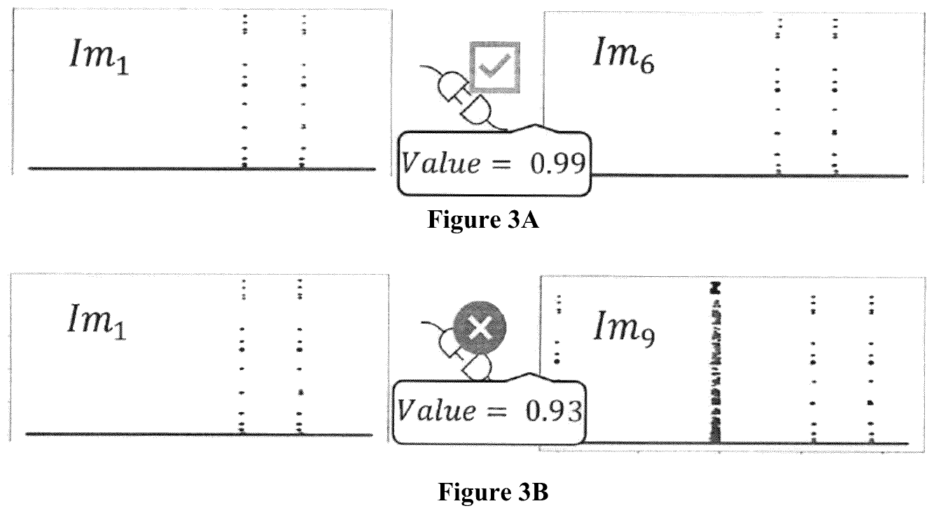

FIGS. 3A and 3B illustrate an example similarity evaluation performed on image files. In the illustrated example, a first image Im₁ is shown being compared to a sixth image Im₆ (FIG. 3A) and a ninth image Im₉ (FIG. 3B) extracted from the corresponding windows of the bitstream. The threshold is given as ∝ₜₕᵣₑₛ=0.97; therefore any images with a SSIM value less than 0.97 will not include an edge and images with a SSIM value greater than 0.97 will have an edge added (in some cases the threshold value is included in the relation for adding an edge while in other cases, the SSIM value must be above the threshold value in order to add the edge). Referring to FIG. 3A, the first image and the sixth image have a similarity value of 0.99. Because the similarity value is above the threshold (e.g., 0.97), an edge is added between the first image and the sixth image. In FIG. 3B, the first image and the ninth image have a similarity value of 0.93. Because the similarity value is below the threshold (0.97), an edge is not added between the first image and the ninth image. Advantageously, the images satisfying the threshold check can be grouped together because there is some determined connection between them. In this manner, the determination method captures the spatial connection connectivity among the images even if the attacker distributes the malicious signature. The threshold ∝ₜₕᵣₑₛ can be obtained using hyper-parameter tuning.

Returning to FIGS. 2A and 2B, performing (240) a classification of the FPGA bitstream as benign or malicious using the graph 235 as input to a graph convolutional network 245 can include generating node embeddings from the graph using a GCN 245 having a feature vector generated at least from applying a Fast Fourier Transform on each bitstream window (see e.g., FIG. 4B); and performing machine learning inference on the node embeddings. Performing machine learning inference on the node embeddings can include inputting the node embeddings to multilayer perceptron (MLP) 250.

As described in more detail with respect to FIG. 4B, in addition to the first set of features generated from applying the FFT, the feature vector can further include a feature set generated from inputting the bitstream windows to a CNN. The CNN can be used to reduce the dimensionality of the features found in the images 214 of the FPGA bitstream 212. Of course, other ways to reduce dimensionality of the non-overlapping windows 222 of the FPGA bitstream 212 may be used.

FIGS. 4A and 4B illustrate an example implementation of a method of detecting stealthy bitstreams in FPGAs. Referring to FIGS. 4A and 4B, example method 400 for detecting stealthy bitstreams in FPGAs can include receiving (410) an FPGA bitstream 412 for configuring an FPGA; partitioning (420) the FPGA bitstream 414 into non-overlapping windows 422; inputting (430) the non-overlapping windows 422 of the FPGA bitstream to a CNN 432 to generate a first feature set 434; converting (440) each bitstream window of the non-overlapping windows 422 of the FPGA bitstream 412 to an image (of images 414); generating (450) a graph 452 from the images 414 using a similarity evaluation; generating (460) node embeddings 462 from the graph using a GCN 464 having a feature vector 466 including a combination of the first feature set 434 and a second feature 436 set generated from applying a Fast Fourier Transform 468 on each bitstream window 422; and performing (470) machine learning inference on the node embeddings 462 using an MLP 472 to classify the FPGA bitstream as benign 474 or malicious 476.

Partitioning (420) the FPGA bitstream 414 into non-overlapping windows 422 ensures that every window is treated independently, so there is no redundant information captured in contiguous windows. The FPGA bitstream is partitioned into ψ non-overlapping windows 422 (Wᵢ). FPGA bitstreams can include numerous features (on the order of 10⁸ for a VU440 bitstream). This can be challenging for traditional ML-based classification algorithms. Advantageously, an SVM can handle high-dimensional datasets. Accordingly, an SVM can be used to determine an optimal ψ number of windows to partition a bitstream into. To determine an optimum value of ψ, training data of known benign and known malicious bitstreams are partitioned into a number of non-overlapping windows. Each set of a specified number of benign and malicious windows are trained on a corresponding number of identical SVM classifiers. The average training accuracy obtained from the corresponding number of SVM classifiers are used in determining the optimum value of ψ. In some cases, the choice of ψ can depend on the specific FPGA bitstream and is obtained by hyperparameter tuning. For example, for a VU440 FPGA bitstream, the size of each window is

$$\frac{128966372}{ψ} .$$

The generated high-dimensional windows 422 can be challenging for direct use as feature matrices to a GCN 464 model. Accordingly, the non-overlapping windows 422 of the FPGA bitstream are input (430) to the CNN 432 to generate a first feature set 434. CNN 432 is a regularized type of feed-forward neural network that learns features by itself via filter (or kernel) optimization. The CNN 432 can reduce the dimensionality of the windows (Wᵢ) 422. In addition, while the CNN 432 reduces the dimensionality of the windows (Wᵢ) 422, the CNN 432 is able to capture bitstream patterns that can be used for subsequent evaluation by the GCN 464 model. In particular, the output of the CNN 432 includes feature set 1 434.

In detail, for the i^{th} bitstream window Wᵢ, 1≤i≤ψ, the reduced feature vector for the

$${i}^{th} window {eF}_{1}^{i} = f ( {W}_{i} ) .$$

where f denotes the convolution and pooling transformations applied by a CNN model. The output of the CNN model is a reduced feature matrix

$${F}_{1} : \{ {F}_{1}^{i} \} ,$$

where the dimensions of F₁ is ψ×k (where k is the number of features obtained after reduction).

In addition to the features identified from the CNN, other features can be included as part of a feature matrix for the GCN 464. For example, a second feature vector can be generated by performing a Fast Fourier Transform (FFT) on each window 422 of the bitstream 412. FFT captures frequency domain characteristics, potentially aiding in the identification of specific patterns, including those indicative of malicious behavior. The FFT-derived feature vector

$${F}_{2}^{i}$$

for each window Wᵢ 422 can be obtained to generate the second feature set 436 in feature matrix

$${F}_{2} : \{ {F}_{2}^{i} \} .$$

Converting (440) each bitstream window of the non-overlapping windows 422 of the FPGA bitstream 412 to an image and generating (450) the graph 452 from the images 414 using a similarity evaluation can be performed as described with respect to operations 220 and 230 of FIG. 2A and the similarity evaluation 232 of FIG. 2B.

Generating (460) node embeddings 462 from the graph using the GCN 464 having a feature vector 466 including a combination of the first feature set 434 and a second feature 436 set generated from applying a Fast Fourier Transform 468 on each bitstream window 422 involves inputting a feature matrix (of feature vector 466) and an adjacency matrix (indicated by graph 452) to the GCN 464 model. As can be seen in FIG. 4B, the GCN 464 receives both an adjacency matrix input (e.g., graph 452) and a feature matrix input (e.g., feature vector F 466).

The GCN 464 model generates node embeddings 462 (given as

$${H}_{i}^{l}$$

for window Wᵢ, 1≤i≤ψ), which capture the low-dimensional representations of each node in the graph based on its neighboring nodes. Next, an average of the ψ node embeddings is taken in order to generate a single graph embedding for the bitstream, denoted by

$${M}^{l} = \frac{1}{ψ} {\sum }_{i = 1}^{ψ} {H}_{i}^{l} .$$

The graph embedding M^{l} is input to the MLP 472 model, which is used to perform (470) machine learning inference on the node embeddings 462.

The MLP 472 is a neural network that has an input layer and an output layer, with one or multiple hidden layers in between. The output of MLP 472 can pass through a series of activation functions, allowing the model to distinguish between benign and malicious embeddings. In this manner, the MLP 472 can classify the FPGA bitstream as benign 474 or malicious 476.

FIG. 5 shows a representation of a system for detection of stealthy bitstreams in FPGAs. Referring to FIG. 5, a system 500 for detecting stealthy bitstreams in FPGAs can include: a CNN 510; a GCN 520; a MLP 530; one or more processors 540; memory 550; and instructions for detecting stealthy bitstreams in FPGAs stored in the memory that when executed by at least one of the one or more processors direct the system to perform method 200 and/or method 400 as described herein. FPGA bitstreams can be input via an input interface 560 to system 500 and inferencing results (e.g., prediction of malicious or benign) can be output via output interface 570. Output interface 570 can enable communication with other systems and devices which may perform actions in response to the inferencing results, including protective measures such as preventing inclusion of associated FPGA bitstreams (predicted as being malicious) to be used to update FPGA hardware. Input interface 560 and output interface 570 can include a wired or wireless network interface and/or other communications interface (e.g., board or package interface). A local storage resource 580 may be included to store feature sets/weights and/or models for the CNN 510, GCN 520, MLP 530, and other components of methods 200 and/or 400.

Methods and data for training of the CNN 510, GCN 520, MLP 530 can be stored at or access by system 500. Similarly, the methods and data for training SVMs (for selection of number of windows) and optimizing similarity evaluation thresholds can also be stored at or accessed by system 500. In one training process, a training loss for binary classification by the MLP is determined by comparing the MLP's predictions to ground truth labels. The training loss guides weight updates across the CNN 510, GCN 520, and MLP 530 models during training. N_{epoch} iterations of training of the pipeline can be run to generate resulting models. The ∝ₜₕᵣₑₛ metric influences edge creation in the graph representation. A grid search can be applied to determine the ∝ₜₕᵣₑₛ value that yields the highest training accuracy of MLP. This value is considered optimum for the given family of FPGA bitstreams, and remains fixed during inferencing, which ensures that the model processes new FPGA bitstreams with the same threshold, maintaining consistency.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

What is claimed is:

1. A method of detecting stealthy bitstreams in field programmable gate arrays (FPGAs), comprising:
receiving an FPGA bitstream for configuring an FPGA;
converting the FPGA bitstream into images;
generating a graph from the images using a similarity evaluation; and
performing a classification of the FPGA bitstream as benign or malicious using the graph as input to a graph convolutional network.

2. The method of claim 1, wherein converting the FPGA bitstream into images comprises:
partitioning the FPGA bitstream into non-overlapping windows; and
converting each bitstream window of the non-overlapping windows of the FPGA bitstream to an image.

3. The method of claim 2, wherein partitioning the FPGA bitstream into non-overlapping windows comprises:
using a support vector machine to determine an optimal number of windows.

4. The method of claim 2, further comprising:
reducing dimensionality of the non-overlapping windows of the FPGA bitstream.

5. The method of claim 4, wherein reducing dimensionality of the non-overlapping windows of the FPGA bitstream comprises:
inputting the non-overlapping windows of the FPGA bitstream to a convolutional neural network.

6. The method of claim 1, wherein generating a graph from the images using a similarity evaluation comprises:
assigning each image as a node of the graph;
obtaining a similarity value between image pairs of the images; and
adding an edge between the two nodes corresponding to the two images of each image pair having the similarity value above a threshold.

7. The method of claim 6, wherein the similarity value is based on a comparison of features including luminance, contrast, and structure.

8. The method of claim 6, wherein the similarity value is a structural similarity index (SSIM) value calculated as:
$$SSIM ( {Im}_{i} , {Im}_{j} ) = \frac{( 2 {μ}_{{Im}_{i}} {μ}_{{Im}_{j}} + {( {k}_{1} l )}^{2} ) ( 2 {σ}_{{Im}_{i} , {Im}_{j}} + {( {k}_{2} l )}^{2} )}{( {μ}_{{Im}_{i}}^{2} + {μ}_{{Im}_{j}}^{2} + {k}_{1} l ) ( {σ}_{{Im}_{i}}^{2} + {σ}_{{Im}_{j}}^{2} + {k}_{2} l )}$$
wherein Imᵢ is an image of a corresponding bitstream window, wherein (Imᵢ, Imⱼ) is the image pair given 1≤i, j≤total number of windows, and i≠j, wherein μ_{Im}_{ᵢ} and μ_{Im}_{ⱼ} indicate the mean pixel value of Imᵢ and Imⱼ, respectively, wherein
$${σ}_{{Im}_{i}}^{2} and {σ}_{{Im}_{j}}^{2}$$
indicate the variance of Imᵢ and Imⱼ, respectively, wherein σ_{Im}_{ᵢ}_{,Im}_{ⱼ} is the covariance of the image pair, wherein l is the range of the pixel values, and wherein k1 and k2 are predetermined values.

9. The method of claim 1, wherein performing the classification of the FPGA bitstream as benign or malicious using the graph as input to the graph convolutional network comprises:
generating node embeddings from the graph using a graph convolutional network having a feature vector generated at least from applying a Fast Fourier Transform on each bitstream window; and
performing machine learning inference on the node embeddings.

10. The method of claim 9, wherein the feature vector further comprises a feature set generated from inputting the bitstream windows to a convolutional neural network.

11. The method of claim 9, wherein performing machine learning inference on the node embeddings comprises:
inputting the node embeddings to multilayer perceptron.

12. The method of claim 1, wherein the FPGA bitstream comprises dispersed malicious circuits having inverters of ring oscillator circuits distributed across multiple non-contiguous look-up tables (LUTs) of the FPGA, the method comprising classifying the FPGA bitstream as malicious.

13. A system for detecting stealthy bitstreams in field programmable gate arrays (FPGAs), comprising:
a convolutional neural network (CNN);
a graph convolutional network (GCN);
a multilayer perceptron (MLP);
one or more processors;
memory; and
instructions for detecting stealthy bitstreams in FPGAs stored in the memory that when executed by at least one of the one or more processors direct the system to:
receive an FPGA bitstream for configuring an FPGA;
partition the FPGA bitstream into non-overlapping windows;
input the non-overlapping windows of the FPGA bitstream to the CNN to generate a first feature set;
convert each bitstream window of the non-overlapping windows of the FPGA bitstream to an image;
generate a graph from the images using a similarity evaluation;
generate node embeddings from the graph using the GCN having a feature vector comprising a combination of the first feature set and a second feature set generated from applying a Fast Fourier Transform on each bitstream window; and
perform machine learning inference on the node embeddings using the MLP to classify the FPGA bitstream as benign or malicious.

14. The system of claim 13, wherein instructions to generate the graph from the images using the similarity evaluation direct the system to:
assign each image as a node of the graph;
obtain a structural similarity index value between image pairs of the images; and
add an edge between the two nodes corresponding to the two images of each image pair having the structural similarity index value above a threshold.

15. The system of claim 14, wherein the structural similarity index value is based on a comparison of features including luminance, contrast, and structure.

16. The system of claim 14, wherein the structural similarity index (SSIM) value is calculated as:
$$SSIM ( {Im}_{i} , {Im}_{j} ) = \frac{( 2 {μ}_{{Im}_{i}} {μ}_{{Im}_{j}} + {( {k}_{1} l )}^{2} ) ( 2 {σ}_{{Im}_{i} , {Im}_{j}} + {( {k}_{2} l )}^{2} )}{( {μ}_{{Im}_{i}}^{2} + {μ}_{{Im}_{j}}^{2} + {k}_{1} l ) ( {σ}_{{Im}_{i}}^{2} + {σ}_{{Im}_{j}}^{2} + {k}_{2} l )}$$
wherein Imᵢ is an image of a corresponding bitstream window, wherein (Imᵢ, Imⱼ) is the image pair given 1≤i, j≤total number of windows, and i≠j, wherein μ_{Im}_{ᵢ} and μ_{Im}_{ⱼ} indicate the mean pixel value of Imᵢ and Imⱼ, respectively, wherein
$${σ}_{{Im}_{i}}^{2} and {σ}_{{Im}_{j}}^{2}$$
indicate the variance of Imᵢ and Imⱼ, respectively, wherein σ_{Im}_{ᵢ}_{,Im}_{ⱼ} is the covariance of the image pair, wherein l is the range of the pixel values, and wherein k1 and k2 are predetermined values.

17. A computer-readable storage medium storing instructions that when executed cause a system to:
receive an FPGA bitstream for configuring an FPGA deployed on a shared FPGA infrastructure;
convert the FPGA bitstream into images;
generate a graph from the images using a similarity evaluation to analyze spatial relationships between bitstream segments;
perform a classification of the FPGA bitstream as benign or malicious using the graph as input to a graph convolutional network;
analyze the FPGA bitstream for dispersed malicious circuits having components distributed across non-contiguous look-up tables based on the classification; and
prevent deployment of the FPGA bitstream on the shared FPGA infrastructure when malicious dispersed circuits are detected.

18. The computer-readable storage medium of claim 17, wherein instructions to convert the FPGA bitstream into images direct the system to:
partition the FPGA bitstream into non-overlapping windows; and
convert each bitstream window of the non-overlapping windows of the FPGA bitstream to an image.

19. The computer-readable storage medium of claim 17, wherein instructions to generate the graph from the images using the similarity evaluation direct the system to:
assign each image as a node of the graph;
obtain a structural similarity index value between image pairs of the images; and
add an edge between the two nodes corresponding to the two images of each image pair having the structural similarity index value above a threshold.

20. The computer-readable storage medium of claim 17, wherein instructions to generate a graph from the images using a similarity evaluation direct the system to:
assign each image as a node of the graph;
obtain a similarity value between image pairs of the images; and
add an edge between the two nodes corresponding to the two images of each image pair having the similarity value above a threshold.
